(19) United States
(12) Patent Application Publication
(10) Pub. No.: US 2011/0237591 A1
(43) Pub. Date: Sep. 29, 2011

(54) Plant Protection Formulations Comprising Dimethomorph and Dithiocarbamate

(75) Inventors: Torsten Knieriem, Mannheim (DE); Thomas Ottillinger, Schifferstadt (DE)

(73) Assignee: BASF SE, Ludwigshafen (DE)

(21) Appl. No.: 13/132,995

(22) PCT Filed: Dec. 8, 2009
(86) PCT No.: PCT/EP2009/066644

§ 371 Date: Jun. 6, 2011

(30) Foreign Application Priority Data
Dec. 9, 2008 (EP) 08171121.0

(51) Int. Cl. A01N 43/84; A01P 3/00

(52) U.S. Cl. 514/237.5

(57) ABSTRACT

The present invention relates to fungicidal plant protection formulations comprising:
a) dimethomorph as active substance A and
b) at least one active substance B from the group of the dithiocarbamates,
   where the plant protection formulation is formulated as an oil suspension concentrate of the active substances A and B in a liquid organic diluent C which is selected among hydrocarbons, vegetable oils, fatty acid esters and their mixtures, and where the oil suspension concentrate furthermore comprises at least one surface-active substance D.

The present invention relates to fungicidal plant protection formulations comprising:

a) dimethomorph as active substance A and
b) at least one active substance B from the group of the dithiocarbamates.

In general, fungicidal active substances are not employed in their pure form, but in the form of a formulation. Depending on the field of application, and the mode of application, and depending on physical, chemical and biological parameters, the active substances are employed as active substance formulation in the form of a mixture with customary carriers, adjuvants and additives. The combinations with further active substances for widening the spectrum of action and/or for protecting the crop plants are also known. Formulations of agrochemical active substances should generally have good chemical and physical stability, good application properties and user friendliness and a good biological activity combined with high selectivity.

Dimethomorph [IUPAC: 4-[3-(4-chlorophenyl)-3-(3,4-dimethoxyphenyl)acryloyl]morpholine] is a systemic fungicidal active substance and commercially available (see, for example, “The Pesticide Manual” 14th edition (2006), The British Crop Protection Council, pages 347 et seq.).

Dithiocarbamates such as mancozeb, maneb, zineb, propineb and metiram are contact fungicides and also commercially available (see, for example, “The Pesticide Manual” 14th edition (2006), The British Crop Protection Council, pages 646-649 for mancozeb and pages 714 et seq. for metiram).

WO 88/05630 describes active substance compositions of 3,3-bis(phenyl)acrylic acid morpholides such as dimethomorph together with further plant protection active substances, for example mancozeb. Possible formulations which are proposed are emulsifiable concentrates and water-dispersible powders.

Owing to the known chemical instability of dithiocarbamates at elevated temperature in the presence of moisture, dithiocarbamate active substances are, as a rule, formulated as solid formulations such as dispersible powders and granules. In individual cases, aqueous suspension concentrates of mancozeb are also available.

A formulation of dimethomorph together with the fungicidal dithiocarbamate mancozeb is commercially available in the form of water-dispersible granules under the name Acrobat® Plus WG.

The disadvantages of the solid formulations are the development of dust or abraded material, which may become a hazard to the user upon use. A further problem is the lack of resistance of the prior-art formulations to moisture. Thus, the presence of moisture, in particular at higher temperatures, leads to partial decomposition of the dithiocarbamates, even in solid formulations. The concomitant release of ethylenethiourea is a problem for reasons of work hygiene. Moreover, solid formulations, having been stored at elevated temperature, can frequently be difficult to resuspend in water, which makes their handling upon application more difficult. The prior-art formulations of dimethomorph and dithiocarbamates are furthermore not always satisfactory with regard to their biological activity.

It is therefore an object of the present invention to provide a formulation of dimethomorph together with dithiocarbamates, in particular Mancozeb, which formulation overcomes the disadvantages of the prior art.

Surprisingly, it has been found that this object can be achieved by formulating dimethomorph and the at least one active substance from the group of the dithiocarbamates as oil suspension concentrate in a liquid organic diluent C, which is selected among hydrocarbons, fatty acid esters and vegetable oils and their mixtures.

The present invention therefore relates to a fungicidal plant protection formulation comprising, as active substances:

a) dimethomorph as active substance A and
b) at least one active substance B from the group of the dithiocarbamates,
where the plant protection formulation is formulated as an oil suspension concentrate of the active substances A and B in a liquid organic diluent C which is selected among hydrocarbons, vegetable oils, fatty acid esters and their mixtures, and where the plant protection formulation furthermore comprises at least one surface-active substance D.

The invention entails a series of advantages. The formulations according to the invention are also stable at elevated temperatures and/or prolonged storage periods, i.e. the formation of ethylene(thio)urea is not observed, nor is the formation of sediments upon dilution with water, which is frequently the case in conventional granules, in particular upon prolonged storage.

The fungicidal formulations according to the invention have an outstanding fungicidal activity against a broad spectrum of economically significant harmful fungi, in particular Oomycetes. Moreover, the formulations according to the invention are distinguished by a rapid onset of action and a persistent fungicidal activity. Moreover, the disadvantageous effect of rain on the fungicidal activity is much less pronounced than in traditional formulations of these active substances. Furthermore, the curative activity of dimethomorph is enhanced by the formulations.

In the formulations according to the invention, the active substances are present predominantly as finely divided particles which are suspended in the organic diluent. The active substance formulations according to the invention are therefore also referred to as oil suspension concentrates. The oil suspension concentrates according to the invention can also comprise a small amount of active substance A and small amounts of active substance B in dissolved form. The amount of dissolved active substance A will, as a rule, not exceed 20% by weight, in particular 10% by weight, based on the total amount of the active substance A which is present in the formulation. The amount of dissolved active substance B will, as a rule, not exceed 10% by weight, in particular 5% by weight, based on the total amount of the active substance B which is present in the formulation. The particle size of the suspended particles is in the range which is typical of oil suspension concentrates. As a rule, the particles have a mean particle diameter in the range from 0.5 to 20 μm, in particular in the range from 0.8 to 10 μm. The particle sizes specified herein are, unless otherwise indicated, D₅₀ values, i.e. weight average particle diameters as can be determined by light scattering. Preferably, at least 80% by weight, in particular at least 90% by weight, of the particles have particle sizes in the stated ranges. In particular, at least 90% by weight of the particles have a particle diameter of no more then 20 μm, in particular no more than 10 μm. In particular, at least 50% by weight, in particular 80% by weight, of the particles have a particle diameter of no more than 8 μm or even 5 μm.

The formulations according to the invention comprise the plant protection active substance dimethomorph as component A. The amount of dimethomorph is typically in the range of from 1 to 30% by weight, in particular in the range of from 1.5 to 20% by weight and specifically in the range of from 2 to 10% by weight, based on the total weight of the formulation.

The formulations according to the invention comprise at least one fungicidally active dithiocarbamate as component B. Examples for fungicidally active dithiocarbamates are maneb, zineb, mancozeb, propineb and metiram and their mixtures, with mancozeb and metiram and their mixtures being preferred. Mancozeb is a particularly preferred fungicide. The amount of dithiocarbamate is typically in the range of from 10 to 50% by weight, in particular in the range of from 15 to 45% by weight and specifically in the range of from 20 to 40% by weight, based on the total weight of the formulation.

The ratio by weight of the active substances A:B is typically in the range of from 1:50 to 1:1, in particular in the range of from 1:20 to 1:2 and specifically in the range of from 1:10 to 1:3.

Besides the abovementioned active substances, the formulations according to the invention may also comprise further agrochemical active substances, in particular fungicides. In general, they will not exceed 50% by weight, in particular 30% by weight and specifically 10% by weight, based on the total weight of the formulation. If present, the amount of further agrochemical active substance is from 0.1 to 50% by weight, in particular from 0.5 to 30% by weight or from 1 to 20% by weight. In a preferred embodiment, the formulation does not comprise any further active substance or no more than 5% by weight based on the weight of the formulation, or no more than 10% by weight based on the total amounts of active substances A and B of one or more further active substances.

The total amount of active substance A, B and, optionally, further active substance will, as a rule, not exceed 60% by weight, in particular 50% by weight, based on the total weight of the formulation according to the invention and is typically in the range from 11 to 60% by weight, in particular in the range from 17 to 55% by weight and specifically in the range of from 22 to 50% by weight, based on the total weight of the formulation according to the invention.

Preferred further active substances are, in particular, fungicidal active substances from the groups
strobilurins, such as, for example, azoxystrobin, dimoxystrobin, enestroburin, fluoxastrobin, kresoxim-methyl, metominostrobin, picoxystrobin, pyraclostrobin, trifloxystrobin, orysastrobin, methyl-(2-chloro-5-[1-(3-methylbenzyloxyimino)-ethyl]benzyl)carbamate, methyl-(2-chloro-5-[1-(6-methylpyridin-2-ylmethoxy-imino)ethyl]benzyl)carbamate, methyl-2-(ortho-(2,5-dimethylphenyloxy-methylene)phenyl)-3-methoxyacrylate;
sulfonamides, such as, for example, cyazofamid and amisulbrom,
phthalimides, such as, for example, captan, captafol, folpet and thiochlorfenphim, and
quinone fungicides, such as, for example, chloranil, benquinox, dithianon and dichlone.

The formulations according to the invention comprise, as component C, at least one liquid organic diluent which is selected among hydrocarbons and vegetable oils, fatty acid esters, in particular fatty acid alkyl esters and their mixtures (regarding hydrocarbons, see, for example, Römpp Lexikon Chemie, 10th edition, volume 3, page 2202 (1997), Georg Thieme Verlag Stuttgart/New York). Among these, diluents and diluent mixtures which are preferred are those which are liquid under standard conditions (T=273.15 K, p=101.325 kPa).

Liquid means that the diluent has, under standard conditions (standard pressure p=101.325 kPa), a dynamic viscosity at 20° C. (293.15 K) of, as a rule, no more than 1 Pa·s, preferably no more than 500 mPa·s, for example no more than 150 mPa·s, in particular no more than 100 mPa·s, specifically no more than 50 mPa·s, in particular in the range of from 1 to 150 mPa·s, preferably in the range of from 2 to 100 mPa·s and in particular in the range of from 3 to 50 mPa·s (determined as specified in ASTM D 445).

The hydrocarbons can be acyclic (aliphatic) hydrocarbons or else cyclic hydrocarbons, for example aromatic or alicyclic (cycloaliphatic) hydrocarbons. The hydrocarbons are typically liquid and have a dynamic viscosity at 20° C. of, as a rule, no more than 150 mPa·s, in particular no more than 100 mPa·s, specifically no more than 50 mPa·s. It is in particular in the range of from 1 to 150 mPa·s, preferably in the range of from 1.2 to 100 mPa·s and in particular in the range of from 1.5 to 50 mPa·s (determined as specified in ASTM D 445).

Examples of hydrocarbons are:
1) aromatic hydrocarbons, for example aromatics which are substituted by one or more alkyl substituents (for example aromatics which are mono-, di- or trisubstituted by C₁-C₁₀-alkyl) for example benzenes such as toluene, xylenes, mesitylene, ethylbenzene, hydrocarbons having fused aromatic ring systems such as naphthalenes, for example 1-methylnaphthalene, 2-methylnaphthalene or dimethylnaphthalene, or other fused aromatic hydrocarbons such as indane or tetralin,
2) cycloaliphatic hydrocarbons, for example saturated or unsaturated cycloaliphatics which are optionally substituted by one or more alkyl substituents (for example cycloaliphatics which are mono-, di- or trisubstituted by C₁-C₁₀-alkyl), such as cycloalkanes, cycloalkenes or cycloalkynes, for example cyclohexane or methylcyclopentane,
3) aliphatic hydrocarbons, for example linear or branched, saturated or unsaturated aliphatics, preferably C₅-C₁₆-aliphatics, for example alkanes, alkenes or alkynes, such as pentane, hexane, octane, 2-methylbutane or 2,2,4-trimethylpentane.

Mixtures of one or more aromatic hydrocarbons and/or of one or more cycloaliphatic hydrocarbons and/or of one or more aliphatic hydrocarbons may also be present as hydrocarbons. Examples are mixtures of a plurality of aliphatic hydrocarbons, for example commercially available diluents from the ExxsoL®D series, ISOPAR® series, in particular Isopar® H, Isopar® K or BAYOL® series, for example Bayol®85 (EXXONMOBIL CHEMICALS), from the ISANE®IP series or the HYDROSEAL®G series (TOTAL FINA ELF), or mixtures of aromatic and aliphatic hydrocarbons, for example commercially available diluents from the SOLVESSO® series, for example Solvesso®100, Solvesso®150 or Solvesso®200 (EXXONMOBIL CHEMICALS), of the SOLVAREX®/SOLVARO® series (TOTAL FINA ELF) or of the Caromax® series, for example Caromax®28 (Petrochem Carless).

Among the hydrocarbons, aliphatic hydrocarbons are preferred, in particular saturated aliphatic hydrocarbons such as C₅-C₁₆-alkanes, for example from the ExxsoL®D series, from the ISOPAR® series, from the BAYOL® series, from the ISANE®IP series, from the MARCOL® series or from the HYDROSEAL®G series (TOTAL FINA ELF).

Suitable vegetable oils are generally known and commercially available. The term vegetable oils within the meaning of the present invention is understood as meaning for example oils from oil-yielding plant species, such as soya oil, rapeseed oil, corn oil, sunflower oil, cotton seed oil, linseed oil, coconut oil, palm oil, safflower oil, walnut oil, peanut oil, olive oil or castor oil, in particular corn oil.

Preferred vegetable oils are liquid triglycerides of C₁₀-C₂₂-fatty acids, in particular oils from oil-yielding plant species, such as soya oil, rapeseed oil, corn oil, sunflower oil, cotton seed oil, linseed oil, coconut oil, palm oil, safflower oil, walnut oil, peanut oil, olive oil or castor oil, all of which may be refined or unrefined, and specifically corn oil.

Suitable among the fatty acid esters are, besides the abovementioned natural (native) triglycerides of C₁₀-C₂₂-fatty acids mentioned as vegetable oils, in particular also synthetic di- and triesters of glycerol or glycol with C₁₀-C₂₂-fatty acids, and in particular C₁-C₄-alkyl esters, specifically methyl or ethyl esters, of C₁₀-C₂₂-fatty acids. Suitable among the fatty acid esters are in particular C₁-C₄-alkyl-C₁₀-C₂₂-fatty acid esters, in particular methyl or ethyl esters of C₁₀-C₂₂-fatty acids, as can be obtained for example by transesterification of the abovementioned glycerol- or glycol-C₁₀-C₂₂-fatty acid esters with C₁-C₄-alcohols (for example methanol, ethanol, propanol or butanol). The transesterification can be carried out by known methods as are described, for example, in Römpp Chemie Lexikon, 9th edition, volume 2, page 1343, Thieme Verlag Stuttgart. As a rule, the fatty acid esters are liquid and have a dynamic viscosity at 20° C. of, as a rule, no more than 150 mPa·s, in particular no more than 100 mPa·s, specifically no more than 50 mPa·s. It is in particular in the range of from 1 to 150 mPa·s, preferably in the range of from 1.2 to 100 mPa·s and in particular in the range of from 1.5 to 50 mPa·s (determined as specified in ASTM D 445).

Preferred diluents are hydrocarbons, in particular aliphatic hydrocarbons and mixtures of hydrocarbons, in particular of aliphatic hydrocarbons, and mixtures of hydrocarbons, in particular of aliphatic hydrocarbons, with vegetable oils or fatty acid esters, in particular with C₁-C₄-alkyl-C₁₀-C₂₂-fatty acid esters.

In a preferred embodiment of the invention, the percentage of aromatics in the diluent is less than 1% based on the total amount of diluent.

The total amount of diluent in the formulation is typically in the range of from 20 to 80% by weight, in particular in the range of from 30 to 70% by weight and specifically in the range of from 35 to 60% by weight, based on the total weight of the formulation.

In a preferred embodiment, the organic diluent C is a mixture comprising:
C.1 at least one first organic diluent which is selected among aliphatic hydrocarbons and aliphatic hydrocarbon mixtures with a viscosity of from 10 to 150 mPa·s, in particular from 12 to 120 mPa·s and specifically from 12 to 60 mPa·s at 20° C., vegetable oils and fatty acid esters, and
C.2 at least one second organic diluent which is selected among hydrocarbons, in particular aliphatic hydrocarbons and aliphatic hydrocarbon mixtures with a viscosity of less than 10 mPa·s, for example from 1 to <10 mPa·s, in particular from 1.5 to 5 mPa·s at 20° C.

Preferred diluents C.1 are paraffinic hydrocarbons such as liquid paraffins with a viscosity of from 10 to 150 mPa·s, in particular from 12 to 120 mPa·s and specifically from 12 to 60 mPa·s at 20° C., as are commercially available for example under the names ExxsoL®D, BAYOL®, ISANE®IP, MARCOL® or HYDROSEAL®G.

Preferred diluents C.2 are isoparaffinic hydrocarbons such as liquid paraffins with a viscosity of less than 10 mPa·s, typically from 0.4 to less than 10 mPa·s, for example from 1 to <10 mPa·s, more preferably from 1 to 5 mPa·s, in particular from 1.5 to 5 mPa·s at 20° C., as are commercially available for example under the names Isopar® H, K, L and M.

If a mixture of diluents C.1 and C.2 is employed, the weight ratio of C.1 to C.2 is typically in the range of from 1:2 to 20:1, in particular in the range of from 1:1 to 10:1. The amount of diluent C.1 is typically in the range of from 15 to 75% by weight, in particular in the range of from 20 to 60% by weight and specifically in the range of from 25 to 50% by weight, based on the total weight of the formulation. The amount of diluent C.2 in the formulation is typically in the range of from 1 to 50% by weight, in particular in the range of from 4 to 40% by weight and specifically in the range of from 5 to 25% by weight, based on the total weight of the formulation.

The plant protection formulation according to the invention furthermore comprises at least one surface-active substance D. The surface-active substance is also referred to as surfactant hereinbelow. Suitable surface-active substances are, in principle, all the surface-active substances (surfactants) which are conventionally used in the production of plant protection products. These include not only surfactants based on nonaromatics, for example on olefins, aliphatics, heterocycles or cycloaliphatics, for example surface-active alkanols or alkenols or derivatives of alkanols or alkenols, for example alkoxylated, sulfated, sulfonated or phosphated alkanols or alkenols, heterocyclic compounds which are substituted by one or more alkyl groups and then derivatized, for example alkoxylated, sulfated, sulfonated or phosphated heterocyclic compounds, for example pyridine, pyrimidine, triazine, pyrole, pyrrolidine, furan, thiophene, benzoxazole, benzothiazole and triazole compounds, but also surfactants based on aromatics, for example, benzenes or phenols which are substituted by one or more alkyl groups and then derivatized, for example alkoxylated, sulfated, sulfonated or phosphated benzenes or phenols.

Suitable surface-active substances D are generally soluble in the diluent phase and suitable for emulsifying or dispersing the latter, together with active substances suspended therein, upon dilution with water (to give the spray mixture).

Examples of surface-active substances D are listed hereinbelow. Hereinbelow, EO represents a repeat unit derived from ethylene oxide, PO a repeat unit derived from propylene oxide and BO a repeat unit derived from butylene oxide. Examples of surface-active substances from the groups of the surfactants based on nonaromatics are the surfactants of groups d1) to d23) mentioned hereinbelow, preferably of groups d1), d2), d3), d4), d12) and d17) and their mixtures.
d1) aliphatic C₈-C₂₄-alcohols which can be alkoxylated, for example with 1-60 alkylene oxide units, preferably 1-60 EO and/or 1-30 PO and/or 1-15 BO in any sequence. The terminal hydroxyl groups of these compounds can be end-capped by an alkyl, cycloalkyl or acyl radical having 1-24, in particular 1 to 4, carbon atoms. Examples of such compounds are: Genapol® C, L, O, T, UD, UDD, X products from Clariant, Plurafac® and Lutensol®A, AT, ON, TO products from BASF SE, Marlipal®24 and 013 products from Condea, Dehypon® products from Henkel, Berol® products and Ethylan® products from Akzo-Nobel, such as Berol®50 and Ethylan® CD 120;
d2) anionic derivatives of the products described under d1) in the form of ether carboxylates, ether sulfonates, ether sulfates and ether phosphates and of their inorganic salts (for example alkali and alkaline earth metal salts) and organic salts (for example amine or alkanolamine base), such as Genapol®LRO, Sandopan® products, Hostaphat/Hordaphos® products from Clariant;
d3) copolymers consisting of EO, PO and/or BO units, in particular EO/PO block copolymers such as the Pluronic® products from BASF SE and the Synperonic® products from Uniquema with a molecular weight of from 400 to 10⁶ daltons and alkylene oxide adducts of C₁-C₉-alcohols such as Atlox®5000 from Uniquema or Hoe®-S3510 from Clariant;
d4) fatty acid alkoxylates and triglyceride alkoxylates such as the Serdox®NOG products from Condea and alkoxylated vegetable oils such as soya oil, rapeseed oil, corn oil, sunflower oil, cotton seed oil, linseed oil, coconut oil, palm oil, safflower oil, walnut oil, peanut oil, olive oil or castor oil, in particular rapeseed oil, for example the Emulsogen® products from Clariant;
d5) salts of aliphatic, cycloaliphatic or olefinic carboxylic acids and polycarboxylic acids, and alpha-sulfo-fatty acid esters as available from Henkel;
d6) fatty acid amide alkoxylates such as the Comperlan® products from Henkel or the Amam® products from Rhodia;
d7) alkylene oxide adducts of alkynediols such as the Surfynol® products from Air Products. Sugar derivatives such as amino and amido sugars from Clariant. Glucitols from Clariant, alkylpolyglycosides in the form of the APG® products from Henkel or such as sorbitan esters in the form of the Span® or Tween® products from Uniquema or cyclodextrin esters or ethers from Wacker;
d8) surface-active cellulose derivatives, algin derivatives, pectin derivatives and guar derivatives such as the Tylose® products from Clariant, the Manutex® products from Kelco and guar derivatives from Cesalpina;
d9) alkylene oxide adducts based on polyols, such as Polyglykol® products from Clariant;
d10) surface-active polyglycerides and their derivatives from Clariant;
d11) alkylpolyglycosides and their alkoxylated derivatives;
d12) sulfosuccinates, alkanesulfonates, paraffinsulfonates and olefinsulfonates such as Netzer Hoe®S1728, Hostapur®OS, Hostapur®SAS from Clariant;
d13) alkylene oxide adducts of fatty amines;
d14) quaternary ammonium compounds having 8 to 22 carbon atoms (C₈-C₂₂) such as, for example, the Genamin® C, L, O, T products from Clariant;
d15) surface-active, zwitterionic compounds such as taurides, betaines and sulfobetaines in the form of Tegotain® products from Goldschmidt, Hostapon® T and Arkopon® T products from Clariant;
d16) silicone- or silane-based surface-active compounds, such as the Tegopren® products from Goldschmidt and the SE® products from Wacker, and the Bevaloid®, Rhodorsil® and Silcolapse® products from Rhodia (Dow Corning, Reliance, GE, Bayer);
d17) perfluorinated or polyfluorinated surface-active compounds such as Fluowet® products from Clariant, the Bayowet® products from Bayer, the Zonyl® products from DuPont and products of this type from Daikin and Asahi Glass;
d18) surface-active sulfonamides, for example from Bayer;
d19) surface-active polymers with carboxylate groups, for example polyacrylic and polymethacrylic polymers, which optionally have polyethylene oxide side-chains, such as the Sokalan® products from BASF, and polymers based on maleic anhydride and/or on reaction products of maleic anhydride, and maleic-anhydride- and/or maleic-anhydride-reaction-product-comprising copolymers with polyethylene glycols such as the Agrimer®-VEMA products from ISP, surface-active polyamides such as modified gelatine or derivatized polyaspartic acid from Bayer, and their derivatives;
d21) neutral surfactant polyvinyl compounds such as modified polyvinylpyrrolidone such as the Luviskol® products from BASF and the Agrimer® products from ISP or the derivatized polyvinylacetates such as the Mowilith® products from Clariant or the derivatized polyvinyl butyrates such as the Lutonal® products from BASF, the Vinnapas® and the Pioloform® products from Wacker or modified polyvinylalcohols such as the Mowiol® products from Clariant, and surface-active derivatives of Montan waxes, polyethylene waxes and polypropylene waxes such as the Hoechst® waxes or the Licowet® products from Clariant;
d22) polyhalogenated or perhalogenated phosphonates and phosphinates such as Fluowet®-PL from Clariant;
d23) polyhalogenated or perhalogenated neutral surfactants such as, for example, Emulsogen®-1557 from Clariant.

Examples of surface-active substances from the group of the aromatics-based surfactants are the surfactants from groups d24) to d28), preferably groups d24), d26), d27) and d28) mentioned hereinbelow.
d24) (Poly)alkoxylated, in particular polyethoxylated, aromatic compounds such as (poly)alkoxylated phenols[=phenol (poly)alkylene glycol ethers], for example with 1 to 50 alkyleneoxy units in the (poly)alkyleneoxy moiety, the alkylene moiety preferably having in each case 2 to 4 C atoms, preferably phenol reacted with 3 to 10 mols of alkylene oxide, or (poly)alkylphenol alkoxylates [=polyalkylphenol (poly)alkylene glycol ethers], for example with 1 to 12 C atoms per alkyl radical and 1 to 150 alkyleneoxy units in the polyalkyleneoxy moiety, preferably tri-n-butylphenol or triisobutylphenol reacted with 1 to 50 mols of ethylene oxide, or polyarylphenols or polyarylphenol alkoxylates [=polyarylphenol (poly)alkylene glycol ethers], for example tristyrylphenol polyalkylene glycol ethers with 1 to 150 alkyleneoxy units in the polyalkyleneoxy moiety, preferably tristyrylphenol reacted with 1 to 50 mols of ethylene oxide, and their condensates with formaldehyde—preferred among which being alkylphenol reacted with 4 to 10 mols of ethylene oxide, for example commercially available in the form of the Agrisol® products (Akcros), triisobutylphenol reacted with 4 to 50 mols of ethylene oxide, for example commercially available in the form of the Sapogenat® T products (Clariant), nonylphenol reacted with 4 to 50 mols of ethylene oxide, for example commercially available in the form of the Arkopal® products (Clariant), tristyrylphenol reacted with 4 to 150 mols of ethylene oxide, for example from the Soprophor® series such as Soprophor® FL, Soprophor® 3D33, Soprophor® BSU, Soprophor® 4D-384, Soprophor® CY/8 (Rhodia);
d25) compounds which are formally the reaction products of the molecules described under d24) with sulfuric acid or phosphoric acid, and their salts which have been neutralized with suitable bases, for example the acidic phosphoric acid ester of a C₁-C₁₆-alkylphenol ethoxylated with 2 to 10 mols of ethylene oxide, for example the acidic phosphoric acid ester of a nonylphenol reacted with 3 mols or with 9 mols of ethylene oxide, and the triethanolamine-neutralized phosphoric acid ester of the reaction product of 20 mols of ethylene oxide and 1 mol of tristyrylphenol;
d26) benzenesulfonates such as alkyl- or arylbenzenesulfonates, for example acidic (poly)alkyl- and (poly)arylbenzenesulfonates neutralized with suitable bases, for example with 1 to 12 C atoms per alkyl radical or with up to 3 styrene units in the polyaryl radical, preferably (linear) dodecylbenzenesulfonic acid and its oil-soluble salts such as, for example, the alkaline earth metal salts, for example the calcium salt of dodecylbenzenesulfonic acid, the isopropyl ammonium salt of dodecylbenzenesulfonic acid, and acidic (linear) dodecylbenzenesulfonate, commercially available for example in the form of the Marlon® products (Hüls);
d27) lignosulfonates, for example the alkali metal or alkaline earth metal lignosulfonates, such as sodium lignosulfonate or calcium lignosulfonate, or ammonium lignosulfonate such as Ufoxane® 3A, Borresperse AM®320 or Borresperse® NA;
d28) condensates of arylsulfonic acids such as phenolsulfonic acid or naphthalenesulfonic acid with formaldehyde and, optionally, urea, in particular their salts and specifically the alkali metal salts and the alkaline earth metal salts such as calcium salts, for example the Tamol® and Wettol® brands of BASF SE, such as Wettol® D1.

Ethyleneoxy, propyleneoxy and butyleneoxy units, in particular ethyleneoxy units and mixtures of ethyleneoxy and propyleneoxy units, are preferred among the alkyleneoxy units.

Preferred nonionic surface-active substances D.2 are the substances mentioned under d1), in particular alkoxylated C₈-C₂₄-alkanols, the products mentioned in group d4), in particular alkoxylated vegetable oils, the products mentioned in group d24), in particular ethoxylated alkylphenols and ethoxylated tristyrylphenols.

In accordance with an especially preferred embodiment of the invention, the nonionic surface-active substances comprise at least one alkoxylated aliphatic C₈-C₂₄-alcohol, preferably at least one alkoxylated aliphatic C₈-C₂₄-alkanol, in particular at least one ethoxylated and/or propoxylated C₁₀-C₂₀-alkanol, specifically at least one ethoxylated and/or propoxylated C₁₂-C₁₆-alkanol, in particular at least one alkoxylated C₈-C₂₄-alkanol of the formula I

Alk-O-(A-O)ₘ—R (I)

where
Alk is a linear or branched alkyl radical having 8 to 24, in particular 10 to 20, C atoms, or a linear or branched alkenyl radical having 8 to 24, in particular 10 to 20, C atoms,
A in group (A-O)ₘ can be identical or different and is ethanediyl, propanediyl or butanediyl, in particular ethane-1,2-diyl or a combination of ethanediyl and propane-1,2-diyl,
m is 2 to 50, in particular 3 to 30, especially preferably 4 to 20, and
R is hydrogen or C₁-C₁₀-alkyl, in particular hydrogen or especially preferably C₁-C₆-alkyl, specifically hydrogen, methyl or ethyl.

In accordance with another especially preferred embodiment of the invention, the nonionic surface-active substances comprises at least one alkoxylated tristyrylphenol, in particular at least one ethoxylated and/or propoxylated tristyrylphenol, specifically at least one ethoxylated tristyrylphenol, in particular at least one alkoxylated tristyrylphenol of the formula I′

TST-O-(A-O)ₘ—R (I′)

where
TST is a tristyryl radical,
A in group (A-O)ₘ can be identical or different and is ethanediyl, propanediyl or butanediyl, in particular ethane-1,2-diyl or a combination of ethanediyl and propane-1,2-diyl,
m is 2 to 50, in particular 3 to 30, especially preferably 4 to 20, and
R is hydrogen or C₁-C₁₀-alkyl, in particular hydrogen or especially preferably C₁-C₆-alkyl, specifically hydrogen, methyl or ethyl.

Preferred anionic surface-active substances D.1 are the alkylbenzenesulfonates having preferably 8 to 22 C atoms, mentioned under group d26), in particular their alkali metal salts and calcium salts, the lignosulfonates mentioned as group d27), in particular their alkali metal salts and calcium salts, and the condensates mentioned in group d28), in particular their ammonium salts (NH₄⁺), alkali metal salts and calcium salts.

The total amount of surface-active substances D in the formulation is typically in the range of from 1 to 50% by weight, in particular in the range of from 2 to 30% by weight and specifically in the range of from 5 to 25% by weight, based on the total weight of the formulation.

In accordance with a preferred embodiment, the formulations according to the invention comprise at least one anionic surface-active substance D.1, in particular at least one anionic surface-active substance which is selected among the substances mentioned in groups d26), d27) and d28), in particular their ammonium salts (NH₄⁺), alkali metal salts and calcium salts. In accordance with a specific embodiment of the invention, the anionic surface-active substance comprises at least one lignosulfonate, in particular in the form of the alkali metal salt. In accordance with another specific embodiment of the invention, the anionic surface-active substance comprises at least one alkylbenzenesulfonate, in particular in the form of the alkali metal salt or alkaline-earth metal salt, for example calcium dodecylbenzenesulfonate.

The total amount of anionic surface-active substances D.1 in the formulation is typically in the range of from 0.5 to 20% by weight, in particular in the range of from 1 to 15% by weight and specifically in the range of from 2 to 10% by weight, based on the total weight of the formulation.

In accordance with an especially preferred embodiment, the formulations according to the invention comprise, besides the at least one anionic surface-active substance D.1, additionally at least one nonionic surface-active substance D.2. Preferred further nonionic surface-active substances are the substances mentioned under d1), in particular alkoxylated C₈-C₂₄-alkanols, the products mentioned in group d4), in particular alkoxylated vegetable oils, the products mentioned in group d24), in particular ethoxylated phenols. In accordance with an especially preferred embodiment of the invention, the at least one further nonionic surface-active substance comprises at least one alkoxylated aliphatic C₈-C₂₄-alkanol, in particular at least one ethoxylated and/or propoxylated C₁₀-C₂₀-alkanol, specifically at least one ethoxylated and/or propoxylated C₁₂-C₁₆-alkanol, in particular at least one alkoxylated C₈-C₂₄-alkanol of the formula I as defined above, in particular a substance of the formula I in which Alk, A, R and m have the meanings given above as being preferred or as especially preferred. In accordance with another especially preferred embodiment of the invention, the at least one further nonionic surface-active substance comprises at least one alkoxylated tristyrylphenol, in particular at least one ethoxylated and/or propoxylated tristyrylphenol, in particular at least one alkoxylated tristyrylphenol of the formula I′ as defined above, in particular a substance of the formula I′ in which TST, A, R and m have the meanings given above as being preferred or as being especially preferred.

In accordance with another preferred embodiment, the formulations according to the invention comprise, as surface-active substances, a mixture of at least two, in particular 2 or 3, nonionic surface-active substances D.2 which are different from one another. In this case, the at least two surface-active substances D.2 which are different from one another comprise at least one first nonionic surface-active substance D.2.1 with a low HLB value and at least one surface-active substance D.2.2 with a higher HLB value. The term “HLB value” (derived from hydrophilic-lipophilic balance) is a measure for the degree of hydrophilicity or lipophilicity of a surface-active substance. Here and hereinbelow, the HLB value is understood as meaning the HLB value as defined by Griffin (W. C. Griffin, J. Soc. Cosmet. Chem. 1, (1950) p. 311; loc. cit. 5 (1954), p. 249). In the case of nonionic surface-active substances, in particular in the case of nonionic ethoxylates, the HLB value is calculated using the following formula

HLB=20*(M_{H}/M)+C

in which M_{H} is the molar mass of the hydrophilic molecule (oligoethylene oxide group) and M is the molar mass of the surface-active substance and C is a correction factor which, in the case of alliphatic alkyl ethoxylates, is −1.2 and, in the case of aromatic alkyl ethoxylates, −1.9 (one alkyl group) or −4.4 (two alkyl groups). The HLB value for nonionic surface-active substances and the correction factor C are known (see, for example, H. Mollet et al, Formulation Technology, Wiley VCH, Weinheim 2001, p. 70-78). Moreover, the HLB value can be determined via formulae which are familiar to the skilled worker, or else experimental (see H. Mollet, loc. cit.).

The HLB value of the nonionic surface-active substance D.2.1 will, as a rule, amount to no more than 12, in particular no more than 11 and specifically no more than 10 and be, for example, in the range of from 4 to 12, frequently in the range of from 5 to 11 and specifically in the range of from 6 to 10. The HLB value of the nonionic surface-active substance D.2.2 will, as a rule, amount to more than 12, in particular at least 13 and specifically at least 14 and be, for example, in the range of from 12.5 to 18, frequently in the range of from 13 to 17.5 and specifically in the range of from 13.5 to 17.

The nonionic surface-active substance D.2.1 with an HLB value of no more than 12 can be selected from among all abovementioned nonionic surface-active substances which have an HLB value of no more than 12, in particular from 4 to 12 or from 5 to 11 or 6 to 10. Suitable surface-active substances D.2.1 comprise, in particular C₂-C₃-alkoxylated C₈-C₂₂-alkylphenols, sorbitan monofatty acid esters, C₂-C₃-alkoxylated mono-, di- or tristyrylphenyl ethers and compounds of the formula I in which m is in the range of from 2 to 12, each A in each case independently is ethane-1,2-diyl or propane-1,2-diyl, Alk is linear or branched C₈-C₂₄-alkyl or C₈-C₂₄-alkenyl, and R is H or C₁-C₁₀-alkyl.

Especially preferred nonionic surface-active substances D.2.1 are those of the formula I which are selected among ethoxylates and ethoxylate/co-propoxylates of linear or branched C₈-C₂₂-alkanols. Examples of such preferred surface-active substances are ethoxylates of linear or branched C₈₋₂₂-alcohols which are commercially available under the trade names Berol® 50, Berol® 532, Berol® 533, Berol® 535, Berol® OX 91-4 (Akzo); Lutensol® TO3, Lutensol® TO5 and Lutensol® TO7 (BASF SE), and ethoxylate/co-propoxylates of fatty alcohols which are commercially available under the trade names Plurafac® LF 221, Plurafac® LF 300, Plurafac® LF 401 and Plurafac® LF 1200 (BASF).

The nonionic surface-active substance D.2.2 with an HLB value of above 12 can be selected from among all of the abovementioned nonionic surface-active substances which have an HLB value of above 12, in particular from 12.5 to 18, or from 13 to 17.5 or from 13.5 to 17. Suitable surface-active substances D.2.2 comprise, in particular, ethoxylated C₈-C₂₂-alkylphenols with a degree of ethoxylation in the range of from 10 to 50, compounds of the formula I in which m is in the range of from 8 to 50, in particular 10 to 40, each A independently of one another is ethane-1,2-diyl, Alk is linear or branched C₈-C₂₄-alkyl or C₈-C₂₄-alkenyl and R is hydrogen, and ethoxylated tristyrylphenols, in particular those of the formula I′, in which m is a number in the range of from 10 to 50, in particular 12 to 40, R is hydrogen and A is ethane-1,2-diyl.

Examples of such preferred surface-active substances are ethoxylates of tristyrylphenol which are commercially available under the trade names Soprophor® (Rhodia), in particular Soprophor® BSU, Soprophor® S 25 and Soprophor® S 40, and ethoxylates of branched C₁₀-C₂₂-alcohols which are commercially available under the trade names Lutensol® (BASF), in particular Lutensol® TO10, Lutensol® TO15.

The abovementioned surface-active substances are known to the skilled worker and commercially available. An overview can be found, for example, in McCutcheon's “Detergents and Emulsifiers Annual”, MC Publ. Corp., Ridgewood N.J.; Sisley and Wood, “Encyclopedia of Surface active Agents”, Chem. Publ. Co. Inc, N.Y. 1964; Schönfeldt, “Grenzflächenaktive Äthylenoxidaddukte” [Interface-active ethylene oxide adducts], Wiss. Verlagsgesellschaft, Stuttgart 1976; Winnacker-Küchler, “Chemische Technologie” [Chemical technology], volume 7, C. Hauser-Verlag, Munich, 4th edition 1986.

The total amount of nonionic surface-active substances in the formulation, if present, is typically in the range of from 0.5 to 30% by weight, in particular in the range of from 1 to 20% by weight and specifically in the range of from 5 to 15% by weight, based on the total weight of the formulation. The weight ratio of anionic surface-active substance to nonionic surface-active substance in such formulation is typically in the range of from 10:1 to 1:10, in particular in the range of from 5:1 to 1:5.

The compositions according to the invention may comprise, as further component E, one or more substances which modify the rheological properties of the formulation, generally also referred to as thickeners. These include all substances which are known to increase the rheological properties, in other words the viscosity, of the formulation, even when used in small amounts. These include in particular all substances which increase the viscosity of oils, specifically those which are suitable for plant protection formulations.

Examples of substances which are suitable as component E are:
e1) natural silicates and modified natural silicates, such as chemically modified bentonites, hectorites, attapulgites, montmorillonites, smectites or other silicate minerals, such as Bentone® (Elementis), Attagel® (Engelhard), Agsorb® (Oil-Dri Corporation) or Hectorite® (Akzo Nobel), preferably Bentone®,
e2) synthetic silicates or silicic acids, in particular highly disperse silicates and silicic acids from the Sipernat®, Aerosil® or Durosil® series (Degussa), the CAB-O-S I L® series (Cabot) or the Van Gel series (RT. Vanderbilt),
e3) organic thickeners, for example those based on hydrogenated fatty acids and fatty acid derivatives, such as thickeners from the Thixin® or Thixatrol® series (Elementis), and thickeners based on synthetic polymers, for example polyalkyl(meth)acrylates, polyamide thickeners, polyurethane thickeners, xanthan gum, for example the products sold under the name Rhodopol® (Rhodia) and Kelzan® S (Kelco Corp.).

Preferred thickeners are those based on natural or synthetic silicates and silicic acids, for example the substances mentioned in groups e1) and e2).

The total amount of substances of component E in the formulation, if present, is typically in the range of from 0.1 to 10% by weight, in particular in the range of from 0.2 to 8% by weight and specifically in the range of from 0.3 to 5% by weight, based on the total weight of the formulation.

Besides the abovementioned components A to E, the formulations according to the invention may also comprise further customary additives F as are conventionally employed in plant protection formulations. These include antidrift agents, adhesives, penetrants, preservatives, and antifreeze agents, antioxidants, colorants, aromatic substances and antifoams. The amount of such adjuvants will typically not exceed 10% by weight of the formulation.

Suitable antifreeze agents are those from the group of the ureas, diols and polyols, such as ethylene glycol and propylene glycol. Suitable antifoams are those based on silicones. Suitable preservatives, colorants and perfumes are known to the skilled worker, for example from the literature mentioned above in connection with surface-active substances, and from Watkins, “Handbook of Insecticide Dust Diluents and Carriers”, 2nd Ed., Darland Books, Caldwell N.J., H.v. Olphen, “Introduction to Clay Colloid Chemistry”; 2nd Ed., J. Wiley & Sons, N.Y.; C. Marsden, “Solvents Guide”; 2nd Ed., Interscience, N.Y. 1963.

The oil suspension concentrates according to the invention can be prepared by methods known per se for the preparation of oil suspension concentrates, for example by mixing components A to E and, optionally, F. Thus, it is possible for example to initially introduce component C and to add the further components A, B, D, E, optionally residual amounts of C and, optionally, F. Optionally, C may also be mixed with a thickener before the remaining components are added. The resulting oil suspension can subsequently be subjected to fine-milling, optionally after a preliminary milling.

Customary mixing apparatuses which optionally can be heated may be used for preparing the mixtures. For the preliminary milling step, it is possible to use, for example, high-pressure homogenizers or mills which operate on the rotor-stator principle, such as Ultraturax homogenizers, for example from IKA, or toothed colloid mills, for example from Puck. Apparatus which can be used for the fine-graining step can be, for example, batchwise-operating bead mills, for example from Drais, or continuously-operating bead mills, for example from Bachofen. Depending on the properties of the components employed, and on process-engineering and safety aspects and economical reasons, the preparation process can be adapted and, optionally, a pre-grinding step or else a fine-grinding step can be dispensed with.

Components A to E and, optionally, F, which are employed for the preparation may comprise, as secondary component, water, which is recovered in the oil suspension concentrates according to the invention. Therefore, the oil suspension concentrates according to the invention may comprise small amounts of water, in general no more than 5% by weight, in particular no more than 1% by weight, based on the total weight of the formulation.

When used, the formulations according to the invention have an outstanding fungicidal activity against a broad spectrum of economically significant harmful fungi, in particular Oomycetes. The invention therefore furthermore relates to the use of the formulations according to the invention for controlling harmful fungi, in particular on crop plants.

The abovementioned properties and advantages are useful in fungus control practice in order to protect agricultural crops, specifically grapevines and fruits and vegetables such as, for example, potatoes, tomatoes, bulb vegetables such as leeks, spring onions and cooking onions, various types of lettuce; beans, salad and winter radish; cucumbers; young vegetables plants and ornamentals from fungal attack, in particular from attack by Peronospora, Puccinia, Plasmopara and/or Phytophtora species and for treating diseased plants in order to achieve reduced fungal infection and/or to prevent increased fungal infection. In this manner, the yields can be guaranteed and/or increased in terms of quality and quantity. The formulations according to the invention are suitable both for use in the open and for use in the greenhouse. The prior art is exceeded markedly by these novel compositions with regard to the properties described.

The present invention also relates to a method of controlling harmful fungi, in particular in crop plants, which comprises the application of a plant protection formulation according to the invention, preferably in the form of an aqueous dilution.

For use, the formulations according to the invention are optionally diluted in the customary manner, for example by means of water, whereby aqueous emulsions or suspoemulsions are obtained. It may be advantageous to add, to the resulting spray mixtures, further agrochemical active substances (for example tank-mix components in the form of suitable formulations) and/or auxiliaries and additives which are conventionally used, for example self-emulsifying oils such as vegetable oils or liquid paraffins and/or fertilizers. The present invention therefore also relates to such liquid fungicidal compositions which are obtainable by diluting the formulations according to the invention.

The examples which follow are intended to illustrate the invention, without having limiting character.
Anionic surface-active substance AOS1 (group d27)): sodium lignosulfonate (Ufoxane®3A).
Anionic surface-active substance AOS2 (group d28)): calcium dodecylsulfonate (Wettol®EM1).
Anionic surface-active substance AOS3 (group d12)): dioctylsulfosuccinate sodium salt.
Nonionic surface-active substance NOS1 (group d1)): isotridecyl alcohol with 6 ethylene oxide (EO) units, methyl-end-capped (Genapol® X060 methyl ether, Clariant).
Nonionic surface-active substance NOS2 (group d1)): C₁₂₋₁₆ alcohol with 3 EO units, HLB value 8.0.
Nonionic surface-active substance NOS3 (group d1)): C₁₃ alcohol with 7 EO units, HLB value 11-12.
Nonionic surface-active substance NOS4 (group d1)): C₁₀ alcohol with 7 EO units, HLB value 13.
Nonionic surface-active substance NOS5 (group d24)): tristyrylphenol oligoethoxylate with 16 EO units, (Soprophor® BSU, Rhodia).
Nonionic surface-active substance NOS6 (group d1)): C₁₃ alcohol with 10 EO units, HLB value 13.5.
Nonionic surface-active substance NOS7 (group d1)): fatty alcohol alkoxylate (PLURAFAC® LF 221 from BASF SE).
Nonionic surface-active substance NOS8 (group d1)): C₁₃ alcohol with 15 EO units, HLB value 15.5.
Antifoam: silicone oil (Rhodorsil®416, Clariant).
Diluent 1: isoparaffinic hydrocarbon with a viscosity of <2 mPa·s at 25° C. (Isopar® H, Exxon).
Diluent 2: liquid paraffin with a viscosity of 27-37 mPa·s at 20° C., (Bayol®85, Exxon).
Diluent 3: rapeseed oil.
Diluent 4: methyl oleate.

### EXAMPLE 1

37.3 g of diluent 1 were introduced into a receiving vessel, and 5.1 g of dimethomorph were added. After mixing with an Ultra-Turax®, the suspension was milled with the aid of a Dynomill® mill at a speed of approx. 3000 min⁻¹ and an exit temperature of 25-30° C. Thereafter, 8.5 g of the nonionic surface-active substance 1 and 8.5 g of diluent 2 were incorporated using an Ultra-Turrax®. In parallel, a mancozeb premix consisting of 85% by weight of mancozeb and 15% by weight of Ufoxane® 3A was prepared, and aliquots (40.2 g) were stirred into the oil suspension. Thereafter, Rhodorsil® 416 was added, with stirring. After milling, the oil suspension concentrate was stirred for a further 20 minutes and then packaged.

The formulation had the following composition: 5.1% dimethomorph b) 34.2% mancozeb c) 37.3% by weight of diluent 1, c) 8.5% by weight of diluent 2 d) 6% by weight of AOS1, d) 8.5% by weight of NOS1, f) 0.4% by weight of Rhodorsil 416.

### EXAMPLE 2

The oil suspension concentrate was prepared analogously to example 1, but 37.3 g of corn oil were employed instead of diluent 1.

### EXAMPLES 3 to 9

The oil suspension concentrates of examples 3 to 9 were prepared analogously to example 1. The components of the formulations are detailed in table 1 hereinbelow.

TABLE 1

| | Ex. 3 | Ex. 4 | Ex. 5 | Ex. 6 | Ex. 7 | Ex. 8 | Ex. 9 |
|---|---|---|---|---|---|---|---|
| Dimethomorph [g/l] | 60 | 45 | 60 | 60 | 60 | 60 | 60 |
| Mancozeb [g/l] | 400 | 300 | 400 | 400 | 400 | 400 | 400 |
| AOS2 | — | — | — | — | 50 | — | 50 |
| AOS3 | — | — | — | — | — | 10 | — |
| NOS2 | 50 | 50 | 50 | 25 | — | — | — |
| NOS3 | — | — | — | 50 | — | — | — |
| NOS4 | 100 | 100 | 100 | 50 | — | — | — |
| NOS5 | 10 | 10 | 10 | — | — | — | — |
| NOS6 | — | — | — | — | 50 | — | — |
| NOS7 | — | — | — | — | — | 100 | — |
| NOS8 | — | — | — | — | — | — | 50 |
| Diluent 1 [g/l] | 250 | — | 350 | 150 | 100 | 150 | 100 |
| Diluent 2 | — | — | — | to 1 l | — | to 1 l | — |
| Diluent 3 | to 1 l | to 1 l | to 1 l | — | — | — | — |
| Diluent 4 | — | — | — | — | to 1 l | — | to 1 l |

### Application Test: Measurement of the Contact Angle:

The oil suspension concentrate according to the invention of example 1 was diluted with water with a defined water hardness (CIPAC standard water D (342 ppm)) to the use concentration (3 g of oil suspension concentrate in 97 g of water) and one drop was then applied to paraffin film. In parallel, a suspension was also prepared with the water-dispersible granules (2 g of granules (9% dimethomorph+60% mancozeb+3% sodium alkylsulfonate: Acrobat® Plus from BASF SE) in 98 g of CIPAC standard water D), and one drop was then applied to paraffin film. The contact angles of the two drops was determined by means of a microscope and compared with each other. The contact angle of the suspension based on the water-dispersible granules is comparable to the contact angle of pure water (=above 90°). The contact angle of the dilute oil suspension was only 35° and therefore shows considerably better wetting.

### Determination of the Chemical Stability:

The chemical stability of the oil suspension concentrate of examples 1 and 2 was determined by storing individual samples at 40° C. over 4 and 8 weeks and, in a further experiment, over 4 weeks at 40° C. and then 4 weeks at 50° C. The storage samples were analyzed at the beginning of the study and after storage for their ETU content (ETU=ethylenethiourea (toxic degradation product of dithiocarbamates) determined by means of HPLC, eluent water with 0.05% tetrahydrofuran). After 4 and 8 weeks of storage, the ETU content was again measured. Here, no increase in the ETU content was observed after storage for any of the abovementioned storage temperatures. In all cases, the ETU content was below 0.05% by weight.

### Biological Experiments:

Biological experiments were carried out in tomatoes and on grapevines under protective and curative conditions. Here, it emerged that dimethomorph, specifically under these conditions, tends to work better in combination with an oil.

Thus, studies in the open on the foliar attack of grapevine cb. Patricia with the pathogen Plasmopara viticola revealed a disease level of 18% when using the commercially available water-dilutable granules at a total application rate of 1380 g/ha (180 g/ha dimethomorph and 1200 g/ha mancozeb) 5 days after the last application (in total 4 applications at 7-day intervals each, 350-400 l/ha water). When the oil suspension concentrate of example 1 was used with the same total application rate and at the same date, the disease level was 13%.

The oil suspension concentrate of example 1 was studied for its activity against late blight in potatoes, caused by Phytophthora infestans, with artificial inoculation in the field.

The experiments were carried out at two sites in Rheinland-Pfalz under field conditions with a sufficient supply of water and nutrients. In both experiments, the potato variety “Bintje” was used. The formulations were applied in the specified concentrations at 3 dates with 17-day and 9-day intervals. 2 days before the first treatment, an artificial infection with the pathogen was performed. At the application dates, the plants were in growth stage 33 to 69. The study showed that the plants treated with the oil suspension concentrate of example 1 at a total application rate of 1040 g/ha and 1380 g/ha 7 days after the third treatment showed a disease level of 4%, whereas at the same date and at the same application rate, the disease level when the treatment was carried out with the water-dilutable granules was 10%.

The formulations of examples 3 to 9 were studied for their activity against late blight of tomato caused by Phytophthora infestans, with protective and curative treatment.

Leaves of pot-growing tomato plants were sprayed to runoff point with an aqueous dilution of the formulation of the example of the stated active substance concentration. For the protective treatment, the leaves were inoculated 7 days after the treatment with an aqueous sporangia suspension of Phytophthora infestans. For the curative treatment, the plants were inoculated one day before the application of the active substance. Thereafter, the plants were placed into a chamber with 100% atmospheric humidity at temperatures between 18 and 20° C. After 5 days, the late blight disease on the untreated, but infected, control plants had developed to such an extent that it was possible to visually determine the disease level in %. The results are complied in tables 2a and 2b:

TABLE 2a

| | | Disease | Disease |
|---|---|---|---|
| | Active substance | level [%] | level [%] |
| Example | concentration [ppm] | curative | protective |
| Untreated | 0 | 70 | 83.3 |
| 3 | 345 (300 + 45) | 0 | 0 |
| 3 | 172.5 (150 + 22.5) | 0 | 0 |
| Untreated | 0 | 73.3 | 80 |
| 4 | 345 | 0 | 0.3 |
| 4 | 172.5 | 0 | 0.3 |
| 5 | 345 | 0 | 0 |
| 5 | 172.5 | 1.7 | 0.3 |

TABLE 2b
(Protective treatment)

| | Active substance | Disease |
|---|---|---|
| Example | concentration [ppm] | level [%] |
| Untreated | 0 | 73.3 |
| 3 | 86.25 (75 + 11.25) | 3.0 |
| 4 | 86.25 (75 + 11.25) | 3.0 |
| 6 | 172.5 (150 + 22.5) | 1.3 |
| 6 | 86.25 (75 + 11.25) | 2.3 |
| 7 | 172.5 (150 + 22.5) | 4.3 |
| 7 | 86.25 (75 + 11.25) | 2.3 |
| 8 | 172.5 (150 + 22.5) | 3.0 |
| 8 | 86.25 (75 + 11.25) | 2.3 |
| 9 | 172.5 (150 + 22.5) | 1.7 |
| 9 | 86.25 (75 + 11.25) | 1.7 |

1-14. (canceled)

15. A fungicidal plant protection formulation comprising, as active substances,
dimethomorph as active substance A and
at least one active substance B from the group of the dithiocarbamates, where the plant protection formulation is formulated as an oil suspension concentrate of the active substances A and B in a liquid organic diluent C which is selected from the group consisting of hydrocarbons, vegetable oils, fatty acid esters and their mixtures, and where the plant protection formulation furthermore comprises at least one surface-active substance D.

16. The plant protection formulation according to claim 15, wherein the organic diluent C is a mixture comprising:
C.1 at least one first organic diluent C.1 which is selected from the group consisting of aliphatic hydrocarbons and aliphatic hydrocarbon mixtures with a viscosity of from 10 to 150 mPa·s, in particular from 12 to 120 mPa·s and specifically from 12 to 60 mPa·s at 20° C., vegetable oils and fatty acid esters, and
C.2 at least one second organic diluent C.2 which is selected from the group consisting of hydrocarbons and hydrocarbon mixtures with a viscosity of less than 10 mPa·s, in particular from 1.5 to 5 mPa·s at 20° C.

17. The plant protection formulation according to claim 15, comprising dimethomorph in an amount of from 1 to 30% by weight, based on the total weight of the formulation.

18. The plant protection formulation according to claim 17, comprising the active substance B in an amount of from 10 to 50% by weight, based on the total weight of the formulation.

19. The plant protection formulation according to claim 15, comprising at least one anionic surface-active substance D.1.

20. The plant protection formulation according to claim 19, wherein the anionic surface-active substance comprises at least one lignosulfonate.

21. The plant protection formulation according to claim 20, additionally comprising a nonionic surface-active substance D.2.

22. The plant protection formulation according to claim 21, wherein the nonionic surface-active substance comprises at least one surface-active substance of the formula I or I′
Alk-O-(A-O)ₘ—R (I)
TST-O-(A-O)ₘ—R (I′)
where
Alk is a linear or branched alkyl radical having 8 to 24 C atoms or a linear or branched alkenyl radical having 8 to 24 C atoms,
TST is a tristyrylphenyl radical;
A in group (A-O)ₘ can be identical or different and is ethanediyl, propanediyl or butanediyl;
m is 2 to 50; and
R is hydrogen or C₁-C₁₀-alkyl.

23. The plant protection formulation according to claim 15, further comprising at least one thickener E.

24. The plant protection formulation according to claim 23, wherein the thickener is selected from the group of the natural and synthetic silicates.

25. The plant protection formulation according to claim 15, comprising at least a fungicidal active substance selected from the group consisting of strobilurins, sulfonamides, phthalimides and quinone fungicides.

26. A method of controlling harmful fungi in plant crops, fruit crops, vegetable crops or grapevines, comprising applying an aqueous dilution of the plant protection formulation according to claim 15 to the crop plants.

27. The method of claim 26, wherein the organic diluent C is a mixture comprising:
C.1 at least one first organic diluent C.1 which is selected from the group consisting of aliphatic hydrocarbons and aliphatic hydrocarbon mixtures with a viscosity of from 10 to 150 mPa·s, in particular from 12 to 120 mPa·s and specifically from 12 to 60 mPa·s at 20° C., vegetable oils and fatty acid esters, and
C.2 at least one second organic diluent C.2 which is selected from the group consisting of hydrocarbons and hydrocarbon mixtures with a viscosity of less than 10 mPa·s, in particular from 1.5 to 5 mPa·s at 20° C.

28. The method of claim 26, comprising dimethomorph in an amount of from 1 to 30% by weight, based on the total weight of the formulation.

29. The method of claim 28, comprising the active substance B in an amount of from 10 to 50% by weight, based on the total weight of the formulation.

30. The method of claim 26, comprising at least one anionic surface-active substance D.1.

31. The method of claim 30, wherein the anionic surface-active substance comprises at least one lignosulfonate.

32. The method of claim 31, additionally comprising a nonionic surface-active substance D.2.

33. The method of claim 32, wherein the nonionic surface-active substance comprises at least one surface-active substance of the formula I or I′
Alk-O-(A-O)ₘ—R (I)
TST-O-(A-O)ₘ—R (I′)
where
Alk is a linear or branched alkyl radical having 8 to 24 C atoms or a linear or branched alkenyl radical having 8 to 24 C atoms,
TST is a tristyrylphenyl radical;
A in group (A-O)ₘ can be identical or different and is ethanediyl, propanediyl or butanediyl;
m is 2 to 50; and
R is hydrogen or C₁-C₁₀-alkyl.

34. The method of claim 26, further comprising at least one thickener E.

35. The method of claim 34, wherein the thickener is selected from the group of the natural and synthetic silicates.

36. The method of claim 26, comprising at least a fungicidal active substance selected from the group consisting of strobilurins, sulfonamides, phthalimides and quinone fungicides.
